(19) United States
(12) Patent Application Publication
(10) Pub. No.: US 2024/0046852 A1
(43) Pub. Date: Feb. 8, 2024

(54) IMAGE PROCESSING METHOD AND DISPLAY DEVICE

(71) Applicant: REALTEK SEMICONDUCTOR CORP., Hsinchu (TW)

(72) Inventors: Yuh-Wey Lin, Hsinchu (TW); Chun-Hao Huang, Hsinchu (TW)

(73) Assignee: REALTEK SEMICONDUCTOR CORP., Hsinchu (TW)

(21) Appl. No.: 18/228,985

(22) Filed: Aug. 1, 2023

(30) Foreign Application Priority Data
Aug. 2, 2022 (TW) 111129038

(51) Int. Cl. G09G 3/20; G09G 3/34

(52) U.S. Cl. CPC G09G 3/2096; G09G 3/3406; G09G 2354/00; G09G 2370/00; G09G 2320/02; G09G 2320/0626

(57) ABSTRACT

An image processing method and a display device are provided. The image processing method is suitable for the display device. The display device includes an image processor and a panel module. The image processing method includes: when the image processor receives a notification signal from a source to switch the display format, the image processor stores a current image frame in a memory. The image processor provides the current image frame to the panel module, so that the panel module displays the current image frame. The image processor is re-handshaking with the source and the panel module to receive a new image frame provided by the source, and the image processor transmits the new image frame to the panel module, so that the panel module displays the new image frame.

### CROSS-REFERENCE TO RELATED APPLICATION

This non-provisional application claims priority under 35 U.S.C. § 119(a) to Patent Application No. 111129038 filed in Taiwan, R.O.C. on Aug. 2, 2022, the entire contents of which are hereby incorporated by reference.

### BACKGROUND

### Technical Field

The disclosure relates to an image processing method and a display device, in particular to an image processing method capable of avoiding generating a black frame when switching a display format and a display device for executing the image processing method.

### Related Art

In the application of display devices, the user may switch the display format, for example, switch parameters such as resolution, frame rate, color depth, etc., such that the display device fits the current use situation.

In the prior art, when the user selects to switch different display formats through an application program or an on-screen display (OSD), the scaler IC needs to first interrupt image communication with the source and the panel module and then re-handshake with the source and the panel module based on the new display format so as to provide the new image to the panel module. However, when switching the display format, the scaler IC interrupts the image communication with the source and panel module and then restarts it. During this process, the display device has to enter a completely black frame before returning to normal display. Moreover, it takes about 4-5 seconds or more to restart the communication, which makes the display device show the black frame for 4-5 seconds or more, and the user has to wait for the completion of the restart process before seeing the frame again on the display device.

### SUMMARY

The disclosure provides an image processing method suitable for a display device. The display device includes an image processor and a panel module. The image processing method includes: when the image processor receives a notification signal from a source to switch a display format, the image processor stores a current image frame in a memory. The image processor provides the current image frame to the panel module, so that the panel module displays the current image frame. The image processor is re-handshaking with the source and the panel module to receive a new image frame provided by the source and transmit the new image frame to the panel module, so that the panel module displays the new image frame.

In some examples, the switching of the display format includes switching of display timing, version switching of DP interface, version switching of HDMI interface, switching from HDMI 2.1 TMDS mode to HDMI 2.1 FRL mode, switching from DP HBR2 to HBR3, on/off switching of Freesync or on/off switching of HDR, etc.

In some examples, the panel module further includes a timing controller, and the panel module handshakes with the image processor through the timing controller.

In some examples, the panel module further includes a backlight module, and when the panel module sequentially displays the current image frame and the new image frame, the panel module does not turn off the backlight module.

In some examples, the switching of the display format is realized through an application program of an operating system or an on-screen display (OSD) menu of the display device in the source.

In some examples, after the panel module displays the new image frame, the method further includes confirming completion of the switching of the display format through the operating system or the display device.

In some examples, the image processor is a scaler IC.

The disclosure also provides a display device signally connected to a source. The display device includes an image processor and a panel module. When the image processor receives a notification signal from the source to switch a display format, the image processor stores a current image frame in a memory. The panel module is electrically connected to the image processor. The image processor provides the current image frame to the panel module, so that the panel module displays the current image frame. The image processor is re-handshaking with the source and the panel module to receive a new image frame provided by the source and transmit the new image frame to the panel module, so that the panel module displays the new image frame.

In some examples, the memory is built in the image processor.

Based on the above, in order to solve the problem of long-time black frame generated when switching the display format in the prior art, the disclosure provides the image processing method and the display device. Through the image processing method and the display device, the user can complete the switching of the display format instantaneously, and no black frame is generated in the switching process. As a result, the user does not need to wait for the completion of the switching of the display format, and the problem of the black frame generated in the switching process is avoided, so that the user can switch the display format more smoothly.

### BRIEF DESCRIPTION OF THE DRAWINGS

FIG. 1 is a block diagram of a display device according to an example of the disclosure.

FIG. 2 is a flow chart of an image processing method according to an example of the disclosure.

FIG. 3A-FIG. 3C are schematic diagrams showing successive states of a display device when switching a display format according to an example of the disclosure.

FIG. 4A-FIG. 4C are schematic diagrams showing successive states of an existing display device when switching a display format.

### DETAILED DESCRIPTION

Exemplary embodiments are described in detail below. However, the embodiments are merely used as examples for description and do not limit or reduce the protection scope of the disclosure. In addition, some components are omitted in the drawings of the embodiments to clearly show the technical features of the disclosure. The same reference numbers are used in the drawings to indicate the same or similar components.

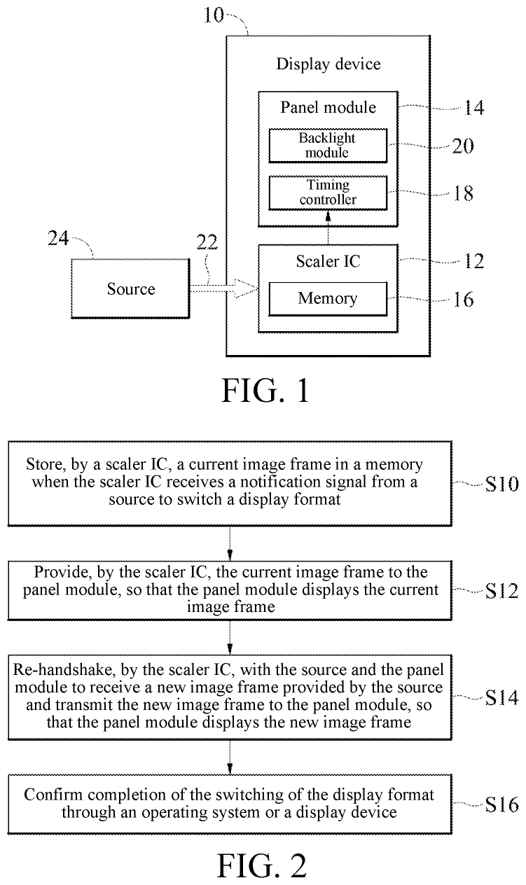

FIG. 1 is a block diagram of a display device according to an example of the disclosure Referring to FIG. 1, a display device 10 includes an image processor, such as a scaler IC 12, and a panel module 14, and the scaler IC 12 is electrically connected to the panel module 14 to transmit image signals. A memory 16 is built in the scaler IC 12 and used to store image frames. A timing controller 18 and a backlight module 20 are disposed in the panel module 14, and the panel module 14 transmits signals with the scaler IC 12 through the timing controller 18, so that the timing controller 18 receives an image frame from the scaler IC 12. In the display device 10, the scaler IC 12 is signally connected to a source 24 via an image transmission interface 22. In an example, the image transmission interface 22 is a High Definition Multimedia Interface (HDMI) or a DisplayPort (DP) interface, and the source 24 is a computer host or a notebook computer.

When the scaler IC 12 receives a notification signal from the source 24 to switch a display format, the scaler IC 12 stores a current image frame in the built-in memory 16, and the scaler IC 12 provides the current image frame from the memory 16 to the timing controller 18 of the panel module 14, so that the panel module 14 displays the current image frame. On the other hand, the scaler IC 12 is re-handshaking with the source 24 and the timing controller 18 of the panel module 14, and after completing the re-handshaking, the scaler IC 12 receives a new image frame provided by the source 24 and transmits the new image frame to the timing controller 18, so that the panel module 14 displays the new image frame instead of the current image frame. In the process of switching the current image frame to the new image frame, the panel module 14 does not turn off the backlight module 20 to save the restart time of the panel module 14.

In an example, the switching of the display format includes switching of display timing, version switching of DP interface, version switching of HDMI interface, switching from HDMI 2.1 TMDS mode to HDMI 2.1 FRL mode, switching from DP HBR2 to HBR3, on/off switching of Freesync or on/off switching of HDR, etc. The switching of the display timing further includes switching of resolution, frame rate, color depth or other parameters.

FIG. 2 is a flow chart of an image processing method according to an example of the disclosure. Referring to FIG. 1 and FIG. 2, the flow of the display device 10 executing the image processing method at least includes step S10 to step S14. When the user selects to switch the display format through an application program in an operating system (OS) or an on-screen display (OSD) menu of the display device 10 in the source 24, the source 24 generates a notification signal corresponding to the display format to be switched, and transmits the notification signal to the scaler IC 12 via the image transmission interface 22. As shown in step S10, when the scaler IC 12 receives the notification signal from the source 24, the scaler IC stores a current image frame currently displayed on the display device 10 in a built-in memory 16. As shown in step S12, the scaler IC 12 provides the current image frame to the panel module 14, so that the panel module 14 displays the current image frame. As shown in step S14, the scaler IC 12 is re-handshaking with the source 24 and the timing controller 18 of the panel module 14, and after completing the re-handshaking, the scaler IC 12 receives a new image frame provided by the source 24 and transmits the new image frame to the timing controller 18 of the panel module 14, so that the panel module 14 displays the new image frame. Thereby, the scaler IC 12 provides the current image frame stored in the memory 16 to the panel module 14 until the scaler IC 12 re-handshakes with the source 24 and the panel module 14, and then provides the new image frame to the panel module 14, so that no black frame is generated in the switching process.

In an example, the scaler IC 12 performs step S12 and step S14 at the same time. In other words, when the scaler IC 12 provides the current image frame to the panel module 14, the scaler IC 12 is also re-handshaking with the source 24 and the timing controller 18 of the panel module 14 until the scaler IC 12 provides the new image frame to the panel module 14. While the scaler IC 12 is re-handshaking with the source 24 and the timing controller 18 of the panel module 14, the scaler IC 12 continuously provides the current image frame to the panel module 14 for display, so that the frame on the display device 10 is not interrupted, thereby avoiding the generation of the black frame.

As shown in FIG. 1 and FIG. 2, after the step of the panel module 14 displaying the new image frame, as shown in step S16, the user may further confirm completion of the switching of the display format through the operating system or the display device 10 of the source 24. In other words, if the user switches the display format through the application program of the operating system of the source 24, then after the switching is completed, the user may still confirm the switching result through the operating system. If the user switches the display format through the OSD menu of the display device 10 of the source 24, then after the switching is completed, the user may still confirm the switching result through the display device 10.

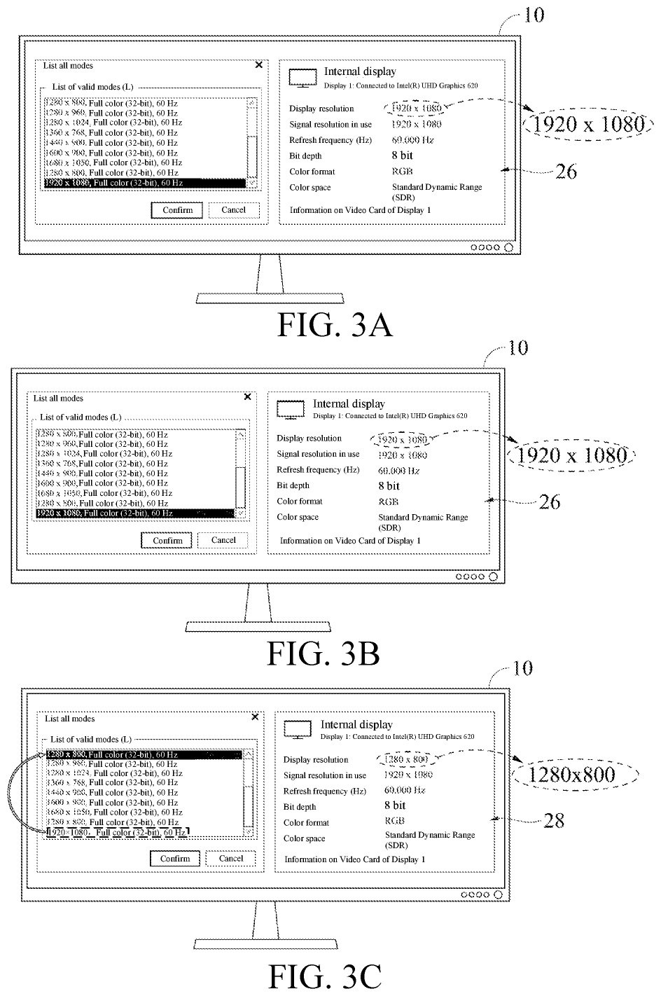

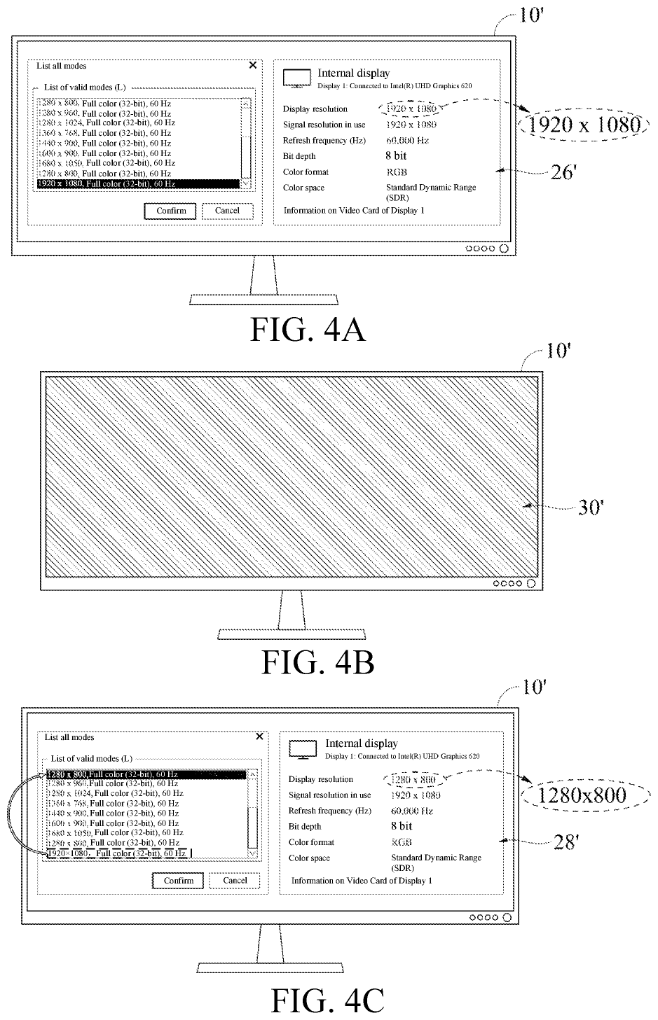

In an example, the technical features of the disclosure are described actually by switching the resolution in the display timing. FIG. 3A-FIG. 3C are schematic diagrams showing successive states of a display device when switching a display format according to an example of the disclosure. FIG. 4A-FIG. 4C are schematic diagrams showing successive states of an existing display device when switching a display format. The effects that the disclosure can achieve are presented by comparing the difference between the disclosure and the prior art.

Referring to FIG. 1, first, as shown in FIG. 3A, when the user selects to switch a display resolution through the OSD menu of the display device 10, the scaler IC 12 receives a notification signal from the source 24, and at this time, the scaler IC 12 stores a current image frame 26 currently displayed on the display device 10 in the memory 16. Then, the scaler IC 12 provides the current image frame 26 to the panel module 14, so that the display device 10 displays the current image frame 26. As shown in FIG. 3B, the frame displayed on the display device 10 is the same as that in FIG. 3A. At this time, the scaler IC 12 is re-handshaking with the source 24 and the panel module 14. After the re-handshaking is completed, the scaler IC 12 receives a new image frame 28 provided by the source 24 and transmits the new image frame to the timing controller 18 of the panel module 14, so that the panel module 14 displays the new image frame 28, as shown in FIG. 3C. The display device 10 has completed the switching of the resolution and is displaying the new image frame 28, and no black frame is generated in the whole switching process.

As shown in FIG. 4A, a display device 10′ is displaying a current image frame 26′. When the user selects to switch the display resolution through an OSD menu of the display device 10′, after a scaler IC receives a notification signal from a source, the scaler IC first interrupts image communication between the source and a panel module. As shown in FIG. 4B, at this time, the display device 10′ displays a black frame 30′ until the scaler IC completes re-handshaking with the source and the panel module, and then the display device displays a new image frame 28′, as shown in FIG. 4C. The display device 10′ has completed the switching of the resolution and is displaying the new image frame 28′. In the whole switching process, the display device 10′ displays the black frame 30′ as shown in FIG. 4B for 4-5 seconds or more, so that the user has to wait for the completion of the restart process before seeing the frame again on the display device 10′. This example takes the switching of the resolution as an example. However, some display timings are related to the change of specification generations, for example, switching from HDMI 2.1 TMDS to HDMI 2.1 FRL, switching of timing from DP HBR2 to HBR3, which may take a longer time and lead to a longer time of the black frame 30′. In contrast, no matter which display format is to be switched, the disclosure can effectively solve the problem of the black frame 30′ and provide the user a better display effect.

Based on the above, in order to solve the problem of long-time black frame generated when switching the display format in the prior art, the disclosure provides the image processing method and the display device. Through the image processing method and the display device, the user can feel that completing the switching of the display format instantaneously, and no black frame is generated in the switching process. As a result, the user does not need to wait for the completion of the switching of the display format, and the problem of the black frame generated in the switching process is avoided, so that the user can switch the display format more smoothly.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An image processing method, suitable for a display device comprising a image processor and a panel module, the image processing method comprising:
storing, by an image processor, a current image frame in a memory when the image processor receives a notification signal from a source to switch a display format;
providing, by the image processor, the current image frame to the panel module, so that the panel module displays the current image frame; and
re-handshaking, by the image processor, with the source and the panel module to receive a new image frame provided by the source and transmit the new image frame to the panel module, so that the panel module displays the new image frame.

2. The image processing method according to claim 1, wherein the switching of the display format comprises switching of display timing, version switching of DP interface, version switching of HDMI interface, switching from HDMI 2.1 TMDS mode to HDMI 2.1 FRL mode, switching from DP HBR2 to HBR3, on/off switching of Freesync or on/off switching of HDR, etc.

3. The image processing method according to claim 1, wherein the panel module further comprises a timing controller, and the panel module handshakes with the image processor through the timing controller.

4. The image processing method according to claim 1, wherein the panel module further comprises a backlight module, and when the panel module sequentially displays the current image frame and the new image frame, the panel module does not turn off the backlight module.

5. The image processing method according to claim 1, wherein the switching of the display format is realized through an application program of an operating system or an on-screen display (OSD) menu of the display device in the source.

6. The image processing method according to claim 5, further comprising confirming completion of the switching of the display format through the operating system or the display device.

7. The image processing method according to claim 1, wherein the memory is built in the image processor.

8. The image processing method according to claim 1, wherein the image processor is a scaler IC.

9. A display device, signally connected to a source, the display device comprising:
an image processor, configured to store a current image frame in a memory when receiving a notification signal from a source to switch a display format; and
a panel module, electrically connected to the image processor, wherein the image processor provides the current image frame to the panel module, so that the panel module displays the current image frame, and the image processor is re-handshaking with the source and the panel module to receive a new image frame provided by the source and transmit the new image frame to the panel module, so that the panel module displays the new image frame.

10. The display device according to claim 9, wherein the switching of the display format comprises switching of display timing, version switching of DP interface, version switching of HDMI interface, switching from HDMI 2.1 TMDS mode to HDMI 2.1 FRL mode, switching from DP HBR2 to HBR3, on/off switching of Freesync or on/off switching of HDR, etc.

11. The display device according to claim 9, wherein the panel module further comprises a timing controller, and the panel module handshakes with the image processor through the timing controller.

12. The display device according to claim 9, wherein the panel module further comprises a backlight module, and when the panel module sequentially displays the current image frame and the new image frame, the panel module does not turn off the backlight module.

13. The display device according to claim 9, wherein the switching of the display format is realized through an application program of an operating system or an on-screen display (OSD) menu of the display device in the source.

14. The display device according to claim 13, wherein completion of the switching of the display format is confirmed through the operating system or the display device.

15. The display device according to claim 9, wherein the memory is built in the image processor.

16. The display device according to claim 9, wherein the image processor is a scaler IC.
